(19) United States
(12) Patent Application Publication
(10) Pub. No.: US 2015/0129693 A1
(43) Pub. Date: May 14, 2015

(54) FOOD GARBAGE DISPOSAL APPARATUS

(71) Applicant: CHUN IL KOH, SEOUL (KR)

(72) Inventor: CHUN IL KOH, SEOUL (KR)

(21) Appl. No.: 14/088,344

(22) Filed: Nov. 23, 2013

(30) Foreign Application Priority Data
Nov. 14, 2013 (KR) 10-2013-0138565

(51) Int. Cl. B02C 18/00; B02C 21/02

(52) U.S. Cl. CPC B02C 18/0092; B02C 21/02
USPC 241/68; 241/101.78; 241/101.3

(57) ABSTRACT

There is provided a food garbage disposal apparatus. The food garbage disposal apparatus includes a food garbage processing unit provided in a housing having an food garbage introduction food garbage introduction opening through which food garbage is input, and configured to decompose and dry the food garbage; and a housing driving unit provided at a lower side of the housing and configured to move the housing on a ground surface, wherein the housing driving unit is configured to move the housing up and down.

### FIELD OF THE INVENTION

The present disclosure relates to a food garbage disposal apparatus.

### BACKGROUND OF THE INVENTION

In general, organic waste such as food garbage contains a large amount of animal and vegetable fibroid materials, protein, carbohydrate, calcium, and so forth. Thus, if the organic waste is buried in the ground without decomposed and disposed of, extracts from the organic waste may permeate into the ground, contaminating soil and subterranean water.

To prevent this problem, there has been a demand for a food garbage disposal apparatus for decomposing and disposing of the organic waste such as food garbage.

As one example of conventional food garbage disposal apparatus, there is known an apparatus of disposing of food garbage or organic waste by turning the food garbage or the organic waste into fertilizer or provender using microorganism (microbes), as disclosed in Korean Utility Model Laid-open Publication No. 20-1994-12627 (FERMENT FERTILIZER'S APPARATUS), Korean Utility Model Laid-Publication No. 20-1994-12628 (ORGANIC FERTILIZERS APPARATUS), Korean Patent Laid-open Publication No. 10-1996-4300 (FERTILIZER USING WASTE FOODS), Korean Utility Model Publication No. 20-1995-7395 (HIGH-SPEED COMPOSTING APPARATUS FOR FOOD GARBAGE) and Korean Utility Model Publication No. 20-1994-24804 (FOOD GARBAGE FERMENTATION APPARATUS), or the like.

Although the above-mentioned conventional methods or apparatuses have an effect of reducing the amount of organic waste, they have following problems. Since it takes a long time to decompose the organic waste, the conventional methods or apparatuses have low processing efficiency. Due to such low processing power, organic waste yet to be completely decomposed may be discharged out, accompanying noxious gas and offensive odor.

Other examples of conventional food garbage disposal apparatus are also disclosed in Korean Utility Model Registration No. 20-270982 (DECOMPOSITION DEVICE OF ORGANIC WASTE), Korean Patent Laid-open Publication No. 10-2006-19663 (REFUSE DISPOSAL MACHINE FOR DISH), Korean Patent Registration No. 10-535699 (AGITATION BARREL STRUCTURE IN FOOD WASTE CLEAN SWEEP APPARATUS), etc.

Among these disclosures, described in Korean Utility Model Registration No. 20-270982 (DECOMPOSITION DEVICE OF ORGANIC WASTE) is an organic waste decomposition device capable of disposing of organic waste at a high speed by using microorganism and heated air. The organic waste decomposition device includes a cylindrical shell case, a shaft, an arm blade, a driving motor and a pre-heater. The cylindrical shell case is fastened to a base frame and stores therein microorganism. The shaft is rotatably fastened to a center of the shell case. The arm blade is coupled to the shaft and is configured to agitate and crush organic waste put into the shell case. The driving motor is configured to provide the shaft with a rotary power, and the pre-heater is configured to pre-heat air supplied into the shell case.

Further, disclosed in Korean Patent Laid-open Publication No. 10-2006-19663 (REFUSE DISPOSAL MACHINE FOR DISH) is a food garbage disposal apparatus including a crushing mill; an agitating and crushing blade provided at a lower part of the crushing mill; and an injection system. In this apparatus, food garbage put into a processing vessel through an food garbage introduction opening is primarily processed by the crushing mill and then is secondarily processed by the agitating and crushing blade. Accordingly, decomposition time can be shortened, and the inside of the processing vessel can be cleaned by the injection system provided within the processing vessel.

Further, described in Korean Patent No. 10-535699 (AGITATION BARREL STRUCTURE IN FOOD WASTE CLEAN SWEEP APPARATUS) is an agitation barrel structure for use in a food garbage disposal apparatus. The agitation barrel structure includes an agitation barrel having a dual structure including an upper bottom with a drain hole and a lower bottom with a drain port; a separable bottom plate coupled to and fixed on the upper bottom of the agitation barrel and having a drain hole; a net provided between the separable bottom plate and the upper bottom; and an agitation blade for agitating food garbage put into the agitation barrel. In this structure, leachate extracted from the food garbage can be drained to the outside through the net, the lower bottom and the drain port. Further, by replacing the separable bottom plate, it is possible to replace the bottom part of the agitation barrel with a new component easily.

Since, however, the aforementioned other examples of conventional food garbage disposal apparatuses are operated by analogue type manual switch devices, manipulating the apparatuses has been inconvenient and it may be impossible to select an operation mode of the apparatuses between an automatic mode and a manual mode. Further, since it is impossible to inject warm water to the inside of the shell case (agitation barrel), food garbage disposal efficiency may be not be sufficiently high. Moreover, since the inside of the shell case (agitation barrel) cannot be washed clean, offensive odor may be generated.

Apparatuses disclosed in Korean Patent Nos. 10-0808132 (FOOD & DRINK WASTE FOR DESTRUCTION EQUIPMENT), 10-0832785 (A DESTRUCTION SYSTEM EQUIPMENT FOR FOOD & DRINK WASTE), 10-0831380 (FOOD & DRINK WASTE FOR DESTRUCTION EQUIPMENT), which were filed by the present applicant prior to the filing date of the present application and later registered, are designed to solve the aforementioned problems that: decomposition takes a long time and processing efficiency is low; noxious gas and offensive odor are generated as a result of discharging food garbage yet to be completely processed; it is inconvenient to manipulate the apparatuses due to their analogue operation mechanisms; an operation mode (automatic or manual) cannot be selected; warm water cannot be injected to the inside of the shell case (agitation barrel) and, thus, food garbage disposal ability is low; and offensive odor is generated due to the failure to clean the inside of the shell case (agitation barrel).

Each of the above patented food garbage disposal apparatuses (or food garbage disposal systems) is configured to be movable by using casters. In order to install the apparatus (or system) at a desired place, however, the whole apparatus needs to be lifted up to remove the casters from the apparatus and install legs instead. For the reason, once the food garbage disposal apparatus is installed, it may be very difficult to move the apparatus to another place.

Further, in general, the food garbage disposal apparatus is installed nearly in contact with a wall surface at the corner of the place so as not to be a hindrance to people moving therein. In such a case, however, since it is difficult for a person to enter a clearance between the wall surface and the food garbage disposal apparatus, leveling off the apparatus has been very difficult.

### BRIEF SUMMARY OF THE INVENTION

In view of the foregoing problems, illustrative embodiments provide a food garbage disposal apparatus that can be installed at any required place without course to an assistant device.

In accordance with an illustrative embodiment, there is provided a food garbage disposal apparatus, including a food garbage processing unit provided in a housing having a food garbage introduction opening through which food garbage is input, and configured to decompose and dry the food garbage; and a housing driving unit provided at a lower side of the housing and configured to move the housing on a ground surface, wherein the housing driving unit is configured to move the housing up and down.

In accordance with the illustrative embodiment, since the food garbage disposal apparatus includes the housing driving unit configured to move the housing up and down. Thus, when moving the food garbage disposal apparatus up and down, a fork lift or other assistant device need not be used. Further, the food garbage disposal apparatus can be installed at the target place easily.

### BRIEF DESCRIPTION OF THE DRAWINGS

Non-limiting and non-exhaustive embodiments will be described in conjunction with the accompanying drawings. Understanding that these drawings depict only several embodiments in accordance with the disclosure and are, therefore, not to be intended to limit its scope, the disclosure will be described with specificity and detail through use of the accompanying drawings, in which:

FIG. 1 is a schematic left side view illustrating a food garbage disposal apparatus in accordance with an illustrative embodiment, in which a left part of a housing is omitted;

FIG. 2 is a schematic right side view illustrating the food garbage disposal apparatus in accordance with the illustrative embodiment, in which a right part of the housing is omitted;

FIG. 3 is a schematic front view illustrating the food garbage disposal apparatus in accordance with the illustrative embodiment, in which a front part of the housing is omitted;

FIG. 4 is a schematic plane view illustrating the food garbage disposal apparatus in accordance with the illustrative embodiment, in which an upper part of the housing is omitted;

FIGS. 5A and 5B are plane views illustrating a housing driving unit in accordance with an illustrative embodiment: FIG. 5A illustrates an operational status of the housing driving unit when a housing is raised and FIG. 5B illustrates an operational status of the housing driving unit when a housing is lowered;

FIG. 6A is a diagram showing a configuration of some components in a part A of FIG. 1 and FIG. 6B is a front view illustrating the configuration of the some components of FIG. 6A;

FIG. 7A is a diagram showing a configuration of some components of a part B in FIG. 1 and FIG. 7B is a front view illustrating the configuration of the some components of FIG. 7A; and

FIG. 8 is a diagram illustrating a data unit in accordance with an illustrative embodiment.

### DETAILED DESCRIPTION OF THE INVENTION

Hereinafter, illustrative embodiments will be described in detail with reference to the accompanying drawings so that inventive concept may be readily implemented by those skilled in the art. However, it is to be noted that the present disclosure is not limited to the illustrative embodiments but can be realized in various other ways. In the drawings, certain parts not directly relevant to the description are omitted to enhance the clarity of the drawings, and like reference numerals denote like parts throughout the whole document.

Through the whole document, the term “on” that is used to designate a position of one element with respect to another element includes both a case that the one element is adjacent to the another element and a case that any other element exists between these two elements.

Through the whole document, the term “comprises or includes” and/or “comprising or including” used in the document means that one or more other components, steps, operation and/or existence or addition of elements are not excluded in addition to the described components, steps, operation and/or elements unless context dictates otherwise. Further, the term “about or approximately” or “substantially” are intended to have meanings close to numerical values or ranges specified with an allowable error and intended to prevent accurate or absolute numerical values disclosed for understanding of the present disclosure from being illegally or unfairly used by any unconscionable third party. Through the whole document, the term “step of” does not mean “step for”.

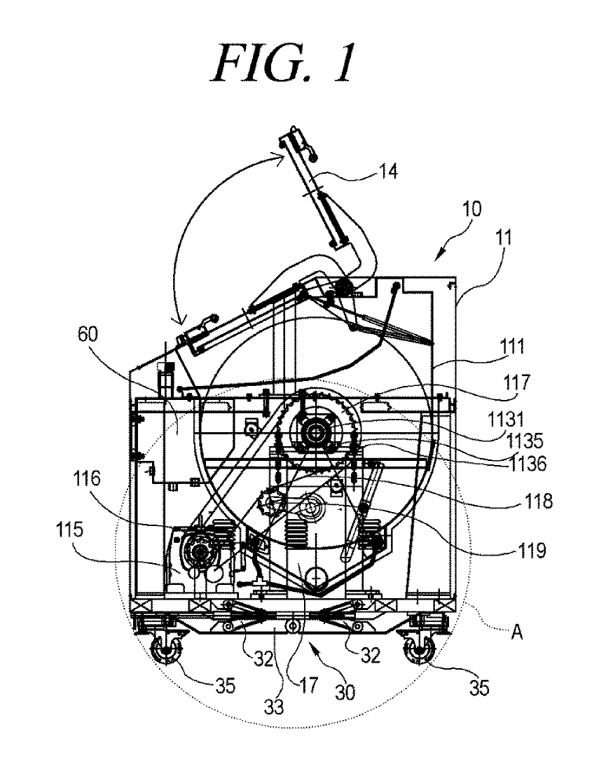

For reference, in the following description, terms related to a direction or a position (front, rear, etc) are defined with respect to an arrangement state of respective components in the drawings. For example, the left side of FIG. 1 will be defined as a front side and the right side of FIG. 1 will be defined as a rear side.

Hereinafter, illustrative embodiments will be described in detail with reference to the accompanying drawings, which form a part hereof.

A food garbage disposal apparatus in accordance with an illustrative embodiment (below, referred to as a “present food garbage disposal apparatus”) will be elaborated.

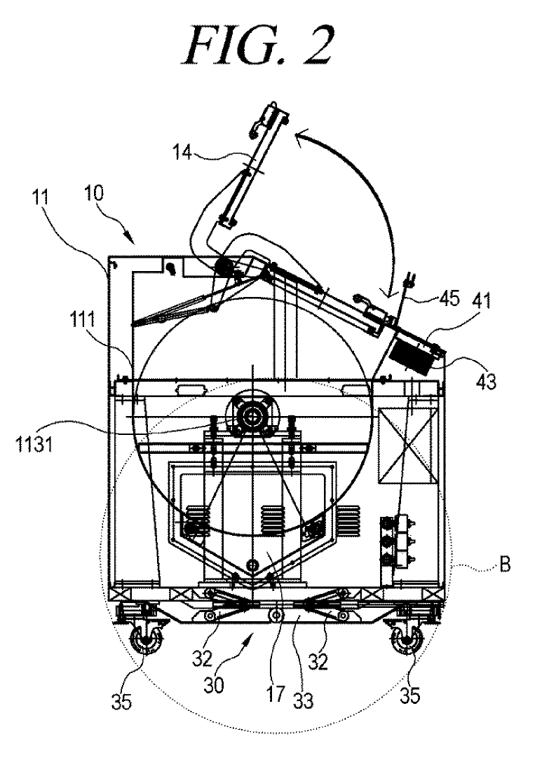

FIG. 1 is a schematic left side view illustrating the food garbage disposal apparatus in accordance with the illustrative embodiment, in which a left part of a housing is omitted. FIG. 2 is a schematic right side view illustrating the food garbage disposal apparatus in accordance with the illustrative embodiment, in which a right part of the housing 11 is omitted.

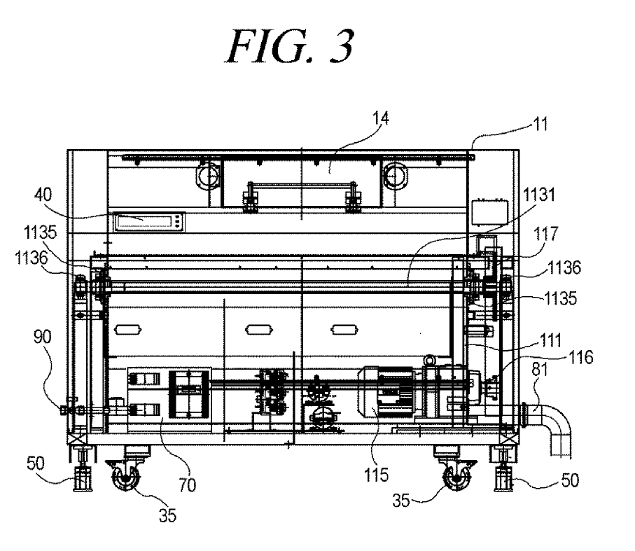

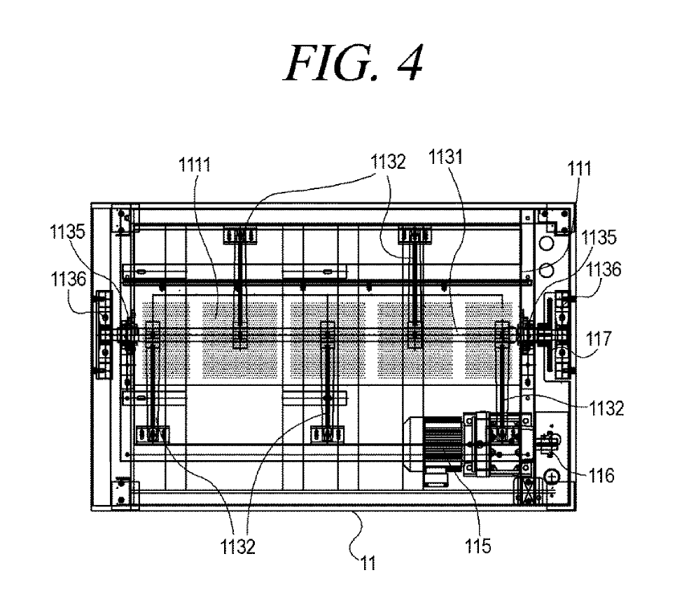

Further, FIG. 3 is a schematic front view illustrating the food garbage disposal apparatus in accordance with the illustrative embodiment, in which a front part of the housing 11 is omitted. FIG. 4 is a schematic front view illustrating the food garbage disposal apparatus in accordance with the illustrative embodiment, in which an upper part of the housing 11 is omitted.

The present food garbage disposal apparatus includes a food garbage processing unit 10 and a housing driving unit 30.

The food garbage processing unit 10 is provided within the housing 11 which has a food garbage introduction opening through which food garbage is input. The food garbage processing unit 10 is configured to decompose and dry the food garbage.

The housing driving unit 30 is provided at a lower side of the housing 11 and is configured to allow the housing 11 to be moved on a ground surface.

The housing driving unit 30 is also configured to move the housing 11 up and down.

With this configuration, the food garbage disposal apparatus can be moved up and down as well as being moved on the ground surface.

Accordingly, after the food garbage disposal apparatus is moved to a place where it is supposed to be installed, the housing 11 may be moved up by the housing driving unit 30, and a space where stopper stands 50 would be installed is provided under the housing 11.

A conventional food garbage disposal apparatus is configured to be moved by using casters. In order to install the food garbage disposal apparatus at a required place, however, the entire apparatus needs to be lifted up, which is troublesome. For this reason, once the conventional food garbage disposal apparatus is installed, it may be very difficult to move the food garbage disposal apparatus to another place.

Further, in general, the conventional food garbage disposal apparatus is installed nearly in contact with a wall surface at the corner of the place so as not to hamper the movement of a person therein. In this case, since it is difficult for a person to enter a clearance between the wall surface and the food garbage disposal apparatus, leveling off the apparatus may be very difficult.

Meanwhile, since the present food garbage disposal apparatus includes the housing driving unit 30 capable of moving the housing 11 up and down, it is not necessary to use a fork lift or another assistance device when moving the housing 11 up and down to install the food garbage disposal apparatus.

Thus, the present food garbage disposal apparatus can be readily installed at the desired place, and an installation place therefor can be easily changed.

In the following, parts related to the above-described configuration will be described in further detail.

The housing driving unit 30 includes an upper frame part 31 on which the housing 11 is arranged; a lower frame part 33 at which casters 34 configured to be rolled along the ground surface are installed; and a lift configured to move the upper frame part 31 up and down relative to the lower frame part 33.

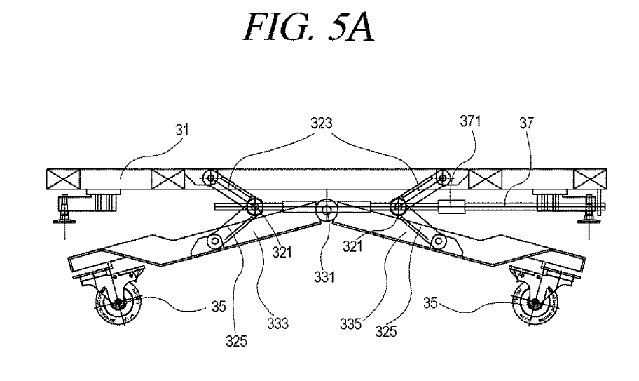

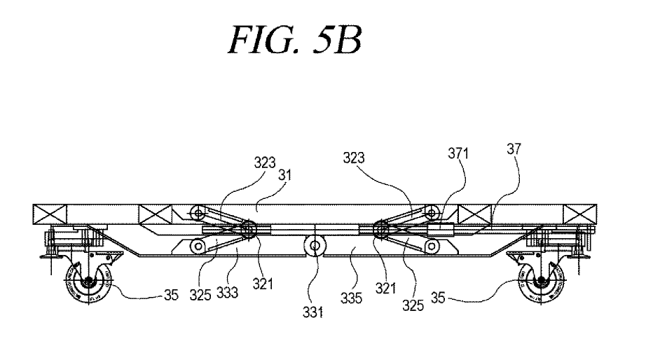

FIGS. 5A and 5B are plane views illustrating the housing driving unit 30 in accordance with an illustrative embodiment. FIG. 5A illustrates an operational status of the housing driving unit 30 when the housing 11 is raised, and FIG. 5B illustrates an operational status of the housing driving unit 30 when the housing 11 is lowered.

The present food garbage disposal apparatus can be easily moved to an installation place through the casters 35 provided at the lower frame part 33. Then, by raising the housing 11 at the installation place by the lift, it is possible to secure a space in which the stopper stands 50 would be installed.

To install and fix the food garbage disposal apparatus in place, the lift is configured to raise the upper frame part 31 up to a certain height that makes the casters 35 to be spaced apart from the ground surface and allows the stopper stands 50 to be installed between the housing 11 and the ground surface.

To fasten the stopper stands 50 to the bottom side of the housing 11, a distance between a bottom surface of the housing 11 and the ground surface needs to be larger than the height of the stopper stands 50, and the casters 35 need to be lifted up above the ground surface.

In this regard, after the present food garbage disposal apparatus is moved on the casters 35 to the installation place, the housing 11 may be lifted up above the height of the stopper stands 50 by the lift, and the stopper stands 50 may be installed under the housing 11.

In the way as described above, the present food garbage disposal apparatus can be installed at the desired place.

The present food garbage disposal apparatus may include the stopper stands 50 provided at the lower side of the housing 11.

The lift may include a pair of lift arms 32. An upper end of each lift arm 32 is equipped to the upper frame part 31, whereas a lower end of each lift arm 32 is equipped to the lower frame part 33.

Here, each of the pair of lift arms 32 may include a first rod 323 of which upper end is hinged to the upper frame part 31; a second rod 325 of which lower end is hinged to the lower frame part 33; and a hinge 321 that links the lower end of the first rod 323 and the upper end of the second rod 325.

Each lift arm 32 may be configured to be rotatable about the hinge 321.

Referring to FIG. 5A, if the hinge 321 is rotated in a direction in which the first rod 323 and the second rod 325 are distanced away from each other, the upper frame part 31 may be moved up.

Meanwhile, referring to FIG. 5B, if the hinge 321 is rotated in a direction in which the first rod 323 and the second rod 325 approach each other, the upper frame part 31 may be moved down.

The lift may further include a guide member 37 configured to guide the hinges 321 of the pair of lift arms 32 to slide in a horizontal direction.

Referring to FIGS. 5A and 5B, the guide member 37 forms a sliding path of the hinges 321 in the horizontal direction, thus allowing the upper frame part 31 to be moved up and down smoothly and stably.

Here, the hinges of the pair of lift arms 32 may be configured to slide symmetrically.

With this configuration, it is possible to move the housing 11 up and down stably while maintaining the leveling (horizontal balance) of the housing 11.

The guide member 37 may have a limit 371 that stops the sliding movement of the hinge 321 over a preset range.

With this configuration, the hinge 321 is allowed to slide within the preset range.

Here, the preset range may imply a movement range of the hinge 321 that allows the housing 11 to be raised within a certain height limit.

That is, if the sliding of the hinge 321 is stopped by the limit 371, the ascent of the housing 11 is also stopped, and the housing 11 can be raised only up to the preset height limit.

By way of example, referring to FIGS. 5A and 5B, the hinge 321 of the left lift arm 32, which is located at the left side among the pair of lift arms 32, is configured to be slidable only to a left end of the guide member 37. Accordingly, the limit 371 may be provided at a position where it allows a movable range of the hinge 321 of the right lift arm 32 located at the right side to be formed in a length corresponding to the length of the movable range of the hinge 321 of the left lift arm 32.

Further, the number of the casters 35 may be plural.

The lower frame part 33 may include a first frame 333 at which some of the plural casters 35 are provided; a second frame 335 at which the others of the plural casters 35 are provided; and a hinge joint 331 provided between the first frame 333 and the second frame 335. A lower end of one of the pair of lift arms 32 is hinged to the first frame 333, and a lower end of the other one of the pair of lift arms 32 is hinged to the second frame 335. The hinge joint 331 is provided between the first frame 333 and the second frame 335 so as to allow the first frame 333 and the second frame 335 to be rotated about a horizontal axis.

When the lift arms 32 are driven, the first frame 333 and the second frame 335 can be rotated about the hinge joint 331 in such a manner as to be inclined downward.

Referring to FIG. 5A, since the casters 35 provided at the first frame 333 and the second frame 335 are capable of supporting the ground surface, the first frame 333 and the second frame 335 can be rotated about the hinge joint 331 so as to be inclined downward when the hinges 321 make sliding motions.

Without the casters 35, the lower frame part 33 itself would be a means to support the ground surface. In such a case, the lower frame part 33 would not be folded as illustrated in FIG. 5A.

Meanwhile, in the present food garbage disposal apparatus, since the casters 35 can be maintained in contact with the ground surface while they rolls, the first frame 333 and the second frame 335 can be rotated about the hinge joint 331 when the hinges 321 make sliding motions.

With this configuration, as the hinges 321 slide, the lift arms 32 are unfolded and, at the same time, the first frame 333 and the second frame 335 are rotated so as to be inclined downward. Accordingly, the maximum ascending height of the upper frame part 31 can be more increased.

Thus, it is possible to lift the housing 11 to a desired height easily just by driving the lift arms 21 at a small distance. Hence, an installation space for the stopper stands 50 can be easily secured.

That is, since the present food garbage disposal apparatus adopts the configuration where the lower frame part 33 can be folded while it is supported by the casters 35, the housing 11 can be lifted up to a height position higher than an ascending amount of the lift arms 32 just by driving the lift arms 32 at a small ascending amount. Therefore, the ascending efficiency of the housing 11 can be improved (see FIG. 5A).

Here, the casters 35 may be provided at two opposite distant ends of the first frames 333 and the second frames 335.

With this configuration, it is possible to suppress interference between the casters 35 provided at the first frames 333 and the second frames 335. Furthermore, the end of the first frames 333 and the end of the second frames 335 can also be prevented from being interfered by the ground surface.

The present food garbage disposal apparatus may include two housing driving units 30 having the above-described configuration. The two housing driving units 30 may be symmetrically installed at the lower side of the housing 11.

With this configuration, it is possible to move the housing 11 up and down while maintaining a balance thereof.

Meanwhile, the food garbage processing unit 10 may include an agitating unit configured to agitate food garbage; and a drain water collecting unit 17 configured to collect drain water discharged from the agitating unit and discharge the drain water.

The agitating unit may include a mixing basin 111; and a mixing unit configured to agitate the food garbage within the mixing basin 111.

If the food garbage is put into the agitating unit through the food garbage introduction opening after an opening/closing door 14 is opened, the agitating unit heats and dries the food garbage put into the mixing basin 111 through the food garbage introduction opening through a door by an adjacent heater (not shown) while agitating the food garbage. Then, the agitating unit discharges the drain water into the drain water collecting unit 17.

The agitating unit may further include a perforated plate 1111 which is provided under the mixing basin 111 and has perforated hole through which the drain water is discharged into the drain water collecting unit 17.

The perforated plate 1111 may be connected to the mixing basin 111 as one body without a gap therebetween.

Conventionally, a plate having holes for allowing drain water to flow therethrough is attached to and detached from a lower portion of an agitator. In such a case, however, foreign substances are stuck in a joint between the lower side of the agitator and the plate.

As a result, the drain water within the agitator could not be drained successfully, which imposes an overload on a motor that drives the agitator.

In contrast, in the present food garbage disposal apparatus, since the perforated plate 1111 and the mixing basin 111 are formed as one body, no gap exists between them, so that it is possible to avoid a problem that foreign substances may be stuck between the perforated plate 1111 and the mixing basin 111.

Accordingly, the drain water can be discharged successfully. Thus, an overload on the agitating unit and a resultant damage on the agitating unit can be avoided, and, besides, efficiency of a drying and decomposing process of the food garbage can be improved.

The agitating unit may further include a welding portion provided between the mixing basin 111 and the perforated plate 1111.

That is, by way of example, the perforated plate 1111 can be formed as one body with the mixing basin 111 by being welded to the mixing basin 111.

The welding portion may imply a portion where the perforated plate 1111 is welded to the mixing basin 111.

However, the welding portion may not be limited thereto. For example, in a case that the perforated plate 1111 is attached to the mixing basin 111 by an adhesive, the welding portion may imply a portion to which the adhesive is applied. That is, the welding portion may imply any of various types of portions existing between the perforated plate 1111 and the mixing basin 111 depending on the way by which the perforated plate 1111 and the mixing basin 111 are coupled as one body.

The drain water discharged from the agitating unit may be discharged to the outside of the food garbage disposal apparatus through a drain pipe 81 shown in FIG. 3.

Here, by way of example, but not limitation, the outside of the food garbage disposal apparatus may be an inside of a BOD (Biochemical Oxygen Demand) reducing apparatus (not shown). The BOD reducing apparatus is configured to ferment and decompose the drain water discharged from the food garbage disposal apparatus and purify the drain water into pure water having a reduced BOD.

One example of such a BOD reducing apparatus is disclosed in Korean Patent Application No. 10-2011-0119269 filed by the present applicant prior to the filing of the present application.

The mixing unit may include a rotational shaft 1131; and one or more mixing blades 1132 equipped the rotational shaft 1131. The rotational shaft 1131 is provided so as to cross the inside of the mixing basin 111 with both ends positioned at two opposite sides of the mixing basin 111.

The rotational shaft 1131 is configured to be rotated by a geared driving motor 115.

To elaborate, referring back to FIG. 1, if the geared driving motor 115 is driven, a driving sprocket 116 is rotated. Accordingly, a driving force is transferred to an interlocked sprocket 117 connected to the driving sprocket 116 by a chain 118, so that the rotational shaft 1131 is rotated.

Here, a tension of the chain 118 is adjusted by a roller type tensioning device 119 and is capable of delivering the driving force to the interlocked sprocket 117.

The one or more mixing blades 1132 are capable of agitating the food garbage, which is put into the mixing basin 111, while being rotated by the rotational shaft 1131.

A UCF (Unit Cylinder Flange) bearing 1135 and a UCP (Unit Cylinder Pillow) bearing 1136 may be provided at both ends of the rotational shaft 1131, respectively.

In the event that the amount of the food garbage is too great or the food garbage is hung on the rotational shaft 1131, for example, a great (strong) load may be applied on the geared driving motor 115. That is, a load over a set load capacity may be imposed on the geared driving motor 115.

As a solution, in the present food garbage disposal apparatus, a double bearing structure including the UFC bearing 1135 and the UCP bearing 1136 is provided at the rotational shaft 1131. Thus, it is possible to prevent bending of the rotational shaft 1131 or damage on the bearings due to the load on the rotational shaft 1131 caused by the input of a great amount of food garbage. That is, higher strength of the mixing unit can be obtained.

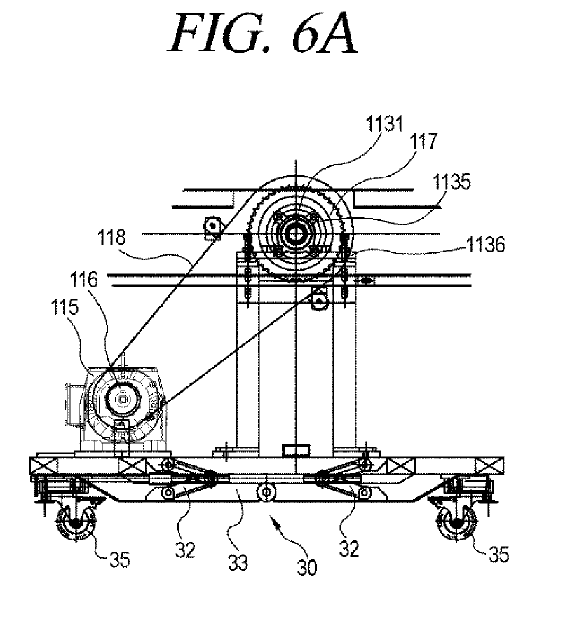

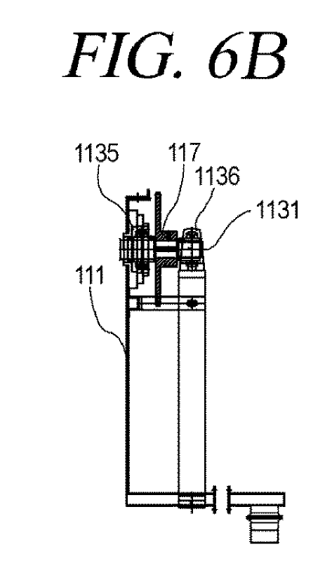

FIG. 6A is a diagram illustrating some components in a part A of FIG. 1. FIG. 6B is a front view illustrating the some components of FIG. 6A for describing the UCF bearing 1135 and the UCP bearing 1136 of the rotational shaft 1131.

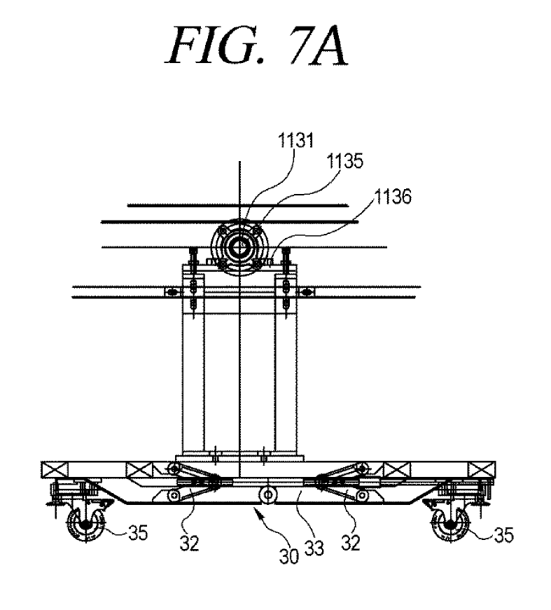

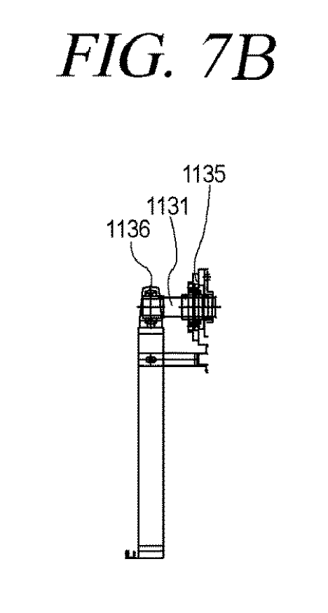

FIG. 7A is a diagram illustrating some components in a part B of FIG. 1. FIG. 7B is a front view illustrating the some components of FIG. 67A for describing the UCF bearing 1135 and the UCP bearing 1136 of the rotational shaft 1131.

As depicted in FIGS. 6A to 7B, the UFC bearing 1135 and the UCP bearing 1136 allow the rotational shaft 1131 to be rotated smoothly, while sustaining a self-weight of the rotational shaft 1131 and a weight applied to the rotational shaft 1131.

The present food garbage disposal apparatus further includes a data unit 70 that stores data related to the amount of the food garbage decomposed and dried by the food garbage processing unit 10.

In using the food garbage disposal apparatus, product models put on the market in U.S., for example, are mostly of a type that is leased by a consumer (user). The user pays for the cost for disposing of food garbage using the food garbage disposal apparatus.

This type of leasing the food garbage disposal apparatus is a new business model. Thus, a sales company that leases the apparatus needs to monitor the amount of the food garbage disposed of by each user on a regular basis, for example, every day, every week or every month.

In this regard, the present food garbage disposal apparatus is capable of providing, through the data unit 70, the sales company with data related to the amount of the food garbage that is disposed of. Based on this data, the sales company that leases the apparatus may render an account according to the amount of the food garbage.

The data unit 70 may include a flow meter configured to measure data regarding the amount of water used by the food garbage processing unit 10; and a watt meter configured to measure data regarding the amount of electricity used by the food garbage processing unit 10.

The food garbage disposal apparatus uses water and electricity in the process of disposing of and decomposing food garbage, especially, in the process of supplying moisture and heat to the food garbage and driving the mixing unit.

Thus, by measuring the amount of water and electricity used, the amount of the food garbage disposed of by the present food garbage disposal apparatus can be counted.

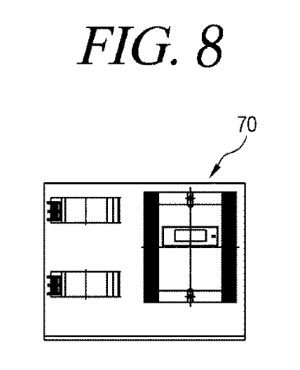

By way of example, the flow meter and the watt meter may be provided as illustrated in FIG. 8.

For example, the data unit 70 including the flow meter and the watt meter may be provided at the left side of an electric device part of the present food garbage disposal apparatus.

Referring back to FIG. 3, the data unit 70 including the flow meter and the watt meter may be provided between a water main supply pipe 90 configured to supply water into the food garbage disposal apparatus and the geared driving motor 115 to which electricity is supplied.

The present food garbage disposal apparatus may further include a communication unit (not shown) configured to transmit data collected by the data unit 70 to a server that monitors the food garbage disposal apparatus.

By way of example, the server may be a server of the sales company that leases the food garbage disposal apparatus.

Thus, the sales company may be capable of collecting data from the data unit 70 through the communication unit by remote control.

As another example, the server may be a server of the user to which the food garbage disposal apparatus is leased.

In such a case, the user may check the amount of usage of the food garbage disposal apparatus on-line by remote control.

By way of example, the communication unit may include a PLC (Power Line Communication) and an Ethernet network card mounted thereon.

The present food garbage disposal apparatus can be moved to a desired installation place through the housing driving units 30 provided at the lower side of the housing 11. Further, at the installation place, the housing 11 can be raised up by the lift, so that a space for the installation of the stopper stands 50 can be easily secured.

Accordingly, without needing to use a fork lift or other assistant devices for lifting up and down the entire apparatus, the food garbage disposal apparatus can be readily installed while maintaining the horizontal balance (leveling) of the housing 11.

Furthermore, in the present food garbage disposable apparatus, the UCF bearing and the UCP bearing are provide at the two opposite sides of the rotational shaft 1131. Through this double bearing structure, the strength of the rotational shaft 1131 can be heightened.

In addition, in the present food disposal apparatus, the perforated plate 1111 and the mixing basin 111 are provided as one unit body. Accordingly, it is possible to prevent a problem that foreign substances are stuck in a joint between the mixing basin 111 and the perforated plate 1111. Therefore, an overload that might be imposed on the rotational shaft 1131 can be prevented.

Moreover, since the present food garbage disposal apparatus includes the data unit 70, the user and the sales company can check the amount of usage of the apparatus on-line by remote control. Especially, the present food garbage disposal apparatus may be applicable to a new business model in which the sales company leases food garbage disposal apparatuses and the user pays for the cost based on the amount of the food garbage disposed of by the food garbage disposal apparatus.

The above description of the illustrative embodiments is provided for the purpose of illustration, and it would be understood by those skilled in the art that various changes and modifications may be made without changing technical conception and essential features of the illustrative embodiments. Thus, it is clear that the above-described illustrative embodiments are illustrative in all aspects and do not limit the present disclosure. For example, each component described to be of a single type can be implemented in a distributed manner. Likewise, components described to be distributed can be implemented in a combined manner.

The scope of the inventive concept is defined by the following claims and their equivalents rather than by the detailed description of the illustrative embodiments. It shall be understood that all modifications and embodiments conceived from the meaning and scope of the claims and their equivalents are included in the scope of the inventive concept.

What is claimed is:

1. A food garbage disposal apparatus comprising:
a food garbage processing unit provided in a housing having a food garbage introduction opening through which food garbage is input, and configured to decompose and dry the food garbage; and
a housing driving unit provided at a lower side of the housing and configured to move the housing on a ground surface,
wherein the housing driving unit is configured to move the housing up and down.

2. The food garbage disposal apparatus of claim 1,
wherein the housing driving unit comprises:
an upper frame part on which the housing is mounted;
a lower frame part at which a caster, which is configured to be rolled along the ground surface, is provided; and
a lift configured to move the upper frame part up and down relative to the lower frame part.

3. The food garbage disposal apparatus of claim 2,
wherein the lift is configured to make the caster be spaced apart from the ground surface and move the upper frame part up to a preset height that allows a stopper stand supporting the housing to be provided between the housing and the ground surface, when installing and fixing the food garbage disposal apparatus in place.

4. The food garbage disposal apparatus of claim 3, further comprising the stopper stand provided at the lower side of the housing.

5. The food garbage disposal apparatus of claim 2,
wherein the lift comprises a pair of lift arms, and
an upper end of each of the pair of lift arms is coupled to the upper frame part and a lower end of each of the pair of lift arms is coupled to the lower frame part.

6. The food garbage disposal apparatus of claim 5,
wherein each of the pair of lift arms comprises:
a first rod of which upper end is hinged to the upper frame part;
a second rod of which lower end is hinged to the lower frame part; and
a hinge that links a lower end of the first rod and an upper end of the second rod.

7. The food garbage disposal apparatus of claim 6,
wherein the lift further comprises a guide member configured to guide the hinge of each of the pair of lift arms to slide in a horizontal direction.

8. The food garbage disposal apparatus of claim 7,
wherein the hinges of the pair of lift arms are configured to slide symmetrically.

9. The food garbage disposal apparatus of claim 7,
wherein the guide member comprises a limit that stops a sliding movement of the hinge over a preset movement range.

10. The food garbage disposal apparatus of claim 5,
wherein the number of the caster is plural,
the lower frame part comprises:
a first frame at which at least one of the plural casters are provided and to which a lower end of one of the pair of lift arms is hinged;
a second frame at which the rest of the plural casters are provided and to which a lower end of the other one of the pair of lift arms; and
a hinge joint provided between the first frame and the second frame so as to allow the first frame and the second frame to be rotated about a horizontal axis, and
the first frame and the second frame are rotatable about the hinge joint so as to be inclined downward as the pair of lift arms are driven.

11. The food garbage disposal apparatus of claim 1,
wherein the number of the housing driving unit is two, and
the two housing driving units are symmetrically installed at the lower side of the housing.

12. The food garbage disposal apparatus of claim 1,
wherein the food garbage processing unit comprises:
an agitating unit configured to agitate the food garbage; and
a drain water collecting unit configured to collect drain water discharged from the agitating unit and discharge the drain water, and
the agitating unit comprises a mixing basin and a mixing unit configured to agitate the food garbage within the mixing basin.

13. The food garbage disposal apparatus of claim 12,
wherein the agitating unit comprises a perforated plate provided under the mixing basin and formed a perforated hole through which the drain water is discharged into the drain water collecting unit, and
the perforated plate is coupled to the mixing basin as one body with the mixing basin so as not to generate a gap between the perforated plate and the mixing basin.

14. The food garbage disposal apparatus of claim 13,
wherein the agitating unit has a welding portion provided between the mixing basin and the perforated plate.

15. The food garbage disposal apparatus of claim 12,
wherein the mixing unit comprises:
a rotational shaft provided so as to cross an inside of the mixing basin with both ends of the rotational shaft installed at two opposite sides of the mixing basin; and
one or more mixing blades equipped to the rotational shaft, and
a UCF bearing and a UCP bearing are provided at the both ends of the rotational shaft.

16. The food garbage disposal apparatus of claim 1, further comprising:
a data unit configured to collect data related to an amount of the food garbage decomposed and disposed of by the food garbage processing unit.

17. The food garbage disposal apparatus of claim 16,
wherein the data unit comprises:
a flow meter configured to measure data regarding an amount of water used by the food garbage processing unit; and
a watt meter configured to measure data regarding an amount of electricity used by the food garbage processing unit.

18. The food garbage disposal apparatus of claim 16, further comprising:
a communication unit configured to transmit the data collected by the data unit to a server that monitors the food garbage disposal apparatus.
